(19) United States
(12) Patent Application Publication
(10) Pub. No.: US 2007/0264402 A1
(43) Pub. Date: Nov. 15, 2007

(54) Flavouring Composition and Method of Flavouring Foodstuffs or Beverages

(75) Inventors: Franciscus Wilhelmus Cornelis den Ouden, Ch Bussum (NL); Migchelsen Judith van den Akker, Huizen (NL); Herman Olsman, Terborg (NL); Johnannes Mattheus Cornelissen, Hilversum (NL)

Correspondence Address: THE WEBB LAW FIRM, P.C., 700 KOPPERS BUILDING, 436 SEVENTH AVENUE, PITTSBURGH, PA, 15219, US

(73) Assignee: Quest International B.V., Naarden (NL)

(21) Appl. No.: 10/577,449

(22) PCT Filed: Oct. 29, 2004
(86) PCT No.: PCT/NL04/00759

§ 371 Date: Mar. 6, 2007

(30) Foreign Application Priority Data
Oct. 30, 2003 (EP) 03078424.3

(51) Int. Cl. A23L 1/22

(52) U.S. Cl. 426/534

(57) ABSTRACT

One aspect of the present invention is concerned with a flavouring composition containing at least 5%, preferably at least 10%, more preferably at least 15% and most preferably at least 20% by weight of dry matter of glycine hydrochloride. The flavouring composition according to the invention is particularly suitable for use in low pH water based foodstuffs and beverages. Other aspects of the invention relate to the use of the aforementioned flavouring composition for flavouring foodstuffs or beverages and to foodstuffs or beverages to which 10% glycine hydrochloride has been added.

### TECHNICAL FIELD OF THE INVENTION

The present invention is concerned with a flavouring composition and a method of flavouring foodstuffs or beverages, said method comprising incorporating into said foodstuff or beverage a flavour imparting amount of the flavouring composition. The flavouring composition according to the invention is particularly suitable for use in low pH water based foodstuffs and beverages.

### BACKGROUND OF THE INVENTION

Acidification of water based foodstuffs and beverages is commonly used to prevent microbial spoilage. By reducing the pH of such products the shelf life may be extended. Also pH reduction may be used to avoid severe heat treatment as it enables effective heat sterilisation under relatively mild conditions. Indeed, pH reduction may even be employed in combination with pasteurisation to achieve sufficiently long shelf life without sterilisation. A drawback of acidification is the sour taste that is inevitably imparted to the acidified product. Solutions have been proposed in the prior art to mask this sour taste.

U.S. Pat. No. 5,766,622, for instance, describes a method of inhibiting an undesirable taste, in oral compositions, such as foods, beverages, and pharmaceuticals by adding a phosphorylated amino acid, such as phosphotyrosine, phosphoserine, phosphothreonine and mixtures thereof to said oral and pharmaceutical compositions. The method is said to be effective in inhibiting undesirable taste selected from the group consisting of sweet, bitter, sour, salty, alkaline, astringent, tangy, sharp, acidic, spicy, pungent, woody, smoky, umami, metallic, any aftertaste and mixtures thereof.

### SUMMARY OF THE INVENTION

The inventors have unexpectedly discovered that flavouring compositions with a high content of glycine hydrochloride can be used advantageously to impart a desirable flavour to low pH water based foodstuffs and beverages. More particularly, the inventors have found that a flavouring composition containing at least 5% by weight of dry matter of said glycine hydrochloride may suitably be employed to prepare flavoured foodstuffs or beverages that combine a low pH with a well balanced flavour and a surprisingly mild sour taste.

U.S. Pat. No. 4,163,803 describes an edible composition for colouring or flavouring a food or beverage, said composition comprising (a) turmeric or a derivative of turmeric containing curcumin, wherein said turmeric or curcumin derivative have a bitter taste; and (b) a glycine in an amount sufficient to substantially reduce or eliminate said bitter taste. The US patent advocates a glycine to turmeric weight ratio of 0.1 to 5. It is stated in the US patent that glycine exists in man forms, such as purified hydrolysed vegetable protein, alpha-glycine, beta-glycine, gamma-glycine, glycine hydrochloride, cationic and anionic salts of glycine, and combinations thereof

U.S. Pat. No. 3,615,698 describes a method for preparing synthetic ham- and bacon-flavoured compositions which comprises preparing an initial mixture in aqueous medium of hexose or pentose monosaccharide or mixtures thereof, cystine or cysteine or mixtures thereof, and glycine in an amount to provide from about 0.05 to about 0.5 part per part by weight of said initial aqueous mixture. U.S. Pat. No. 3,660,114 describes a method for making a chicken-flavoured composition which consists essentially of mixing in an aqueous medium a hexose or pentose monosaccharide or mixtures thereof, cystine or cysteine or mixtures thereof, and glycine in an amount to provide from about 0.05 to about 0.5 part per part by weight of the total mixture. The method described in both US patents involves neutralisation of the aqueous mixture to a pH of about 6.5 to 7.5, followed by heating. In the examples the use of glycine hydrochloride is described. Following neutralisation and heat treatment, the glycine hydrochloride concentration will have declined dramatically.

### DETAILED DESCRIPTION OF THE INVENTION

Accordingly, one aspect of the invention relates to a flavouring composition containing at least 5%, preferably at least 10%, more preferably at least 15% and most preferably at least 20% by weight of dry matter of glycine hydrochloride.

The term “flavouring composition” as used herein refers to a food-grade composition that can be used to impart flavour to foodstuffs or beverages by incorporating it therein in a concentration below 5 wt. %, especially below 3 wt. %.

Glycine hydrochloride is a generally approved food additive. Glycine hydrochloride was found to have a particularly advantageous impact on the taste of the low pH foodstuff or beverage as it “rounds off” the flavour, meaning that prominent taste and/or flavour aspects are somewhat tempered in comparison to less pronounced taste and/or flavour notes.

The flavouring composition according to the present invention may suitably contain a variety of flavouring ingredients as well as other food-grade additives such as colouring agents, emulsifiers and anti-oxidants. The present composition may also contain turmeric components. Typically, the glycine hydrochloride content of the present composition is much higher than the turmeric component concentration. Thus, in a preferred embodiment, in case the composition contains a turmeric component selected from the group consisting of turmeric, a derivative of turmeric containing curcumin and combinations thereof, the weight ratio of turmeric component to glycine hydrochloride is less than 1:5, preferably less than 1:10. Even more preferably, in case the composition contains a turmeric component, the turmeric component is present in a concentration of less than 2%, preferably less than 1% by weight of dry matter

The flavouring composition according to the present invention can take the form of a powder, granules, tablets, a paste or a liquid. In a preferred embodiment, the flavouring composition contains less than 20 wt. % water, more preferably less than 10 wt. % water, and most preferably less than 8 wt. % water.

The present flavouring composition, when employed in aqueous products, may cause a pH reduction due to its high glycine hydrochloride content. Typically, if the present composition is dissolved in deionised water in a concentration of 1 wt. %, calculated on dry matter, the pH of the resulting mixture is below 5.0. Preferably, even if the composition is dissolved in a concentration of 0.5 wt. %, the pH of the resulting mixture is below 5.0.

In a particularly preferred embodiment of the invention, the flavouring composition is a free flowing powder. Free flowing powders offer the advantage of easy dosing and dispersibility. Typically, such a free flowing powder will have a volume weighted mean particle size in the range of 10 μm to 3 mm, preferably in the range of 30-1000 μm, more preferably in the range of 50-500 μm. The flavouring composition may suitably contain carrier materials such as starches, salt, carboxymethylcellulose and combinations thereof. Preferably, the present composition contains at least 10 wt. % carrier material, i.e. an inert material other than glycine hydrochloride, water and flavouring ingredient. Preferably, said carrier material is present in the composition as a particulate solid.

The flavouring composition according to the present invention suitably contains at least 10%, preferably at least 20% and most preferably at least 25% by weight of dry matter of at least one component selected from the group consisting of yeast lysates; processed flavours; extracts of vegetables, herbs, spices and/or fruit; dried vegetables, herbs, spices and/or fruit; monosodium glutamate; ribotides; and topnotes. Most preferably, the aforementioned percentages apply to at least one component selected from the group consisting of yeast lysates, process flavours, monosodium glutamate and topnotes.

The flavouring compositions according to the present invention may suitably take the form of a savoury or a sweet flavour. Typical examples of flavouring compositions according to the invention include broth flavours, meat (incl. fish) flavours, vegetable flavours (e.g. tomato), dairy flavours (e.g. cheese or sour cream) etc. Preferably the flavouring composition is a savoury flavour, especially a broth flavour.

Another aspect of the invention relates to a method of flavouring a foodstuff or a beverage, said method comprising incorporating into said foodstuff or beverage between 0.01 and 5.0 wt. % of a flavouring composition as defined herein before. Preferably, the flavouring composition is incorporated in a concentration of at least 0.02 wt. %, more preferably of at least 0.03 wt. %. Typically, the present flavouring composition will be incorporated in a foodstuff or a beverage in a concentration of less than 3.0 wt. %, preferably of less than 2.0 wt. %.

Particularly good results are obtained with the present method if the flavouring composition is incorporated into a foodstuff or beverage in an amount effective to deliver at least 0.005%, preferably at least 0.01%, more preferably at least 0.03% of glycine hydrochloride by weight of the foodstuff of beverage. Typically, the present method delivers less than 2.0%, more preferably less than 1.5%, most preferably less than 1.0% glycine hydrochloride by weight of the foodstuff or beverage.

In a preferred embodiment, the present method comprises incorporating into a foodstuff or a beverage a food grade acid, preferably a food-grade acid selected from the group consisting of citric acid, lactic acid, acetic acid and combinations thereof Typically, the latter food-grade acid is incorporated in an amount of at least 0.01 wt. %, preferably in an amount of at least 0.03 wt. %. Usually the food-grade acid is incorporated in an amount of not more than 1 wt. %, preferably of not more than 0.7 wt. %, more preferably of not more than 0.5 wt. %. The food-grade acid may be incorporated in the foodstuff or beverage as a constituent of the present flavouring composition or, alternatively, it may be incorporated separately.

As mentioned herein before, the present flavouring composition is particularly suited for flavouring water based foodstuffs and beverages. Preferably, in the present method, the foodstuff or beverage contains at least 20 wt. %, more preferably at least 40 wt. %, and most preferably at least 60 wt. % water. The pH of the foodstuff or beverage, after incorporation of the present flavouring composition is typically within the range of 2.0 and 5.0. Preferably said pH is at least 2.5, more preferably at least 3.0. In a preferred embodiment, the pH will not exceed 4.8, more preferably it will not exceed 4.5.

The present method preferably also includes a sterilisation or pasteurisation step, which is suitably executed by means of a heat treatment. In a particularly preferred embodiment, the present method comprises a pasteurisation step as the combined use of such pasteurisation and the present flavouring composition yields a foodstuff or beverages with exceptional good shelf-life and microbiological stability. In the present method, the flavouring composition may be incorporated after or before pasteurisation, the latter being preferred.

Examples of water based foodstuffs that may suitably be flavoured in accordance with the present method include sauces, soups, dressings, cheese, cooking creams, desserts, vegetables (e.g. canned vegetables) and mayonnaise. Most preferably, the water based foodstuff is a sauce or a soup.

Another aspect of the invention relates to the use of glycine hydrochloride in water based low pH foodstuffs or beverages to suppress and/or mask the sour taste of such foodstuffs or beverages. Typically, this use involves incorporation of the glycine hydrochloride in a concentration within the range of 0.005 to 2.0 wt. %. The benefits of the use of glycine hydrochloride in accordance with the present invention are particularly pronounced in foodstuffs or beverages with a pH of less than 4.5. A further aspect of the invention is concerned with a water containing foodstuff or beverage with a pH of less than 5.0, preferably less than 4.5, even more preferably less than 4.3, wherein said foodstuff or beverage contains at least 0.01 wt. % glycine hydrochloride, between 0 and 0.01 wt. % turmeric, and wherein the weight ratio of glycine hydrochloride to turmeric exceeds 5.

The invention also relates to a foodstuff or beverage with a pH of less than 5.0, preferably less than 4.5, even more preferably less than 4.3, wherein said foodstuff or beverage contains at least 0.05 wt. % glycine hydrochloride.

In a particularly preferred embodiment the foodstuff or beverage according to the invention is water-continuous. Water-continuous food products are often acidified to a low pH to ensure that such products will have sufficient shelf stability. Water continuity of food products can easily be established by methods well-known in the art, e.g. conductivity measurements.

Preferably, the foodstuff or beverage of the invention is a sterilised or pasteurised product. The benefits of the present invention are particularly pronounced in pasteurised foodstuffs or beverages. Properly packaged pasteurised foodstuffs or beverages according to the present invention are characterised by an excellent shelf-life, i.e. typically a shelf-life of at least 6 months or even at least 12 months at 20° C., during which period no microbial spoilage will occur Said foodstuffs or beverages are suitably packages in sealed glass containers (including bottles and jars), cans, cartons (e.g. Tetrapack®), plastic containers (e.g. sealed plastic cups), pouches or bag in box.

Yet another aspect of the invention is concerned with a process of manufacturing a flavouring composition as defined herein before, said process comprising dry blending of glycine hydrochloride. Dry blending of glycine hydrochloride with other constituents of the flavouring composition offers the advantage that reactions between glycine hydrochloride and said other constituents are effectively prevented.

The invention is further illustrated by means of the following examples.

### EXAMPLES

### Example 1

A flavouring composition (A) according to the present invention was prepared from the following ingredients:

| | Weight % |
|---|---|
| Glycine HCl | 40 |
| Mushroom powder | 10 |
| Lactose | 20 |
| Maltodextrin | 19 |
| Monosodium glutamate | 10 |
| Ribotides | 1 |

The aforementioned flavouring composition was used to prepare a mushroom sauce on the basis of the following recipe:

| | Weight (g) |
|---|---|
| Water | 770.90 |
| Wheat flour, Albatros ex Meneba ™ | 8.30 |
| Mod. Starch, Colflo 67 ex Nat. Starch ™ | 37.00 |
| Sugar | 10.00 |
| Salt | 9.00 |
| Butter | 15.00 |
| Cream | 90.00 |
| Xanthan | 1.50 |
| Sauteed mushroom ex Quest ™ (product code 68243) | 3.00 |
| Oven Roast Extract ex Quest ™ (product code 31057) | 0.30 |
| Umamex XLM ex Quest ™ (product code 31054) | 1.00 |
| Mushroom flavour Cantharelle ex Quest ™ | 1.50 |
| (product code QL32313) | |
| Onion powder | 2.00 |
| Garlic powder | 0.50 |
| Mushroom, blanched | 50.00 |
| Garlic powder | 0.50 |
| | 100.00 |

Preparation

The dry ingredients were added to the water, cream, butter and mushrooms and brought to the boil while stirring and held for 2 minutes. The sauce was divided in two equal portions (I) and (II). Flavouring composition (A) and lactic acid (90%) were added to portion (I) in amounts of 0.2 wt. % and 0.17 wt. % respectively. After preparation, the pH of portion (I) of the mushroom sauce was found to be 4.1. The pH of portion (I) was adjusted to 4.1 with lactic acid (90%).

Both portions of the sauce were hot-filled and packaged after pasteurisation (5 minutes at 95° C.) and were found to exhibit excellent shelf-life, i.e. to be microbiologically stable for more than 6 months at 20° C.

A double blind evaluation of portions (I) and (II) revealed that portion (I) was generally preferred as being less sour and having a more balanced taste.

### Example 2

A flavouring composition (B) according to the present invention was prepared from the following ingredients:

| | Weight % |
|---|---|
| Glycine HCl | 25 |
| Lactose | 20 |
| Yeast extract | 10 |
| Maltodextrin | 15 |
| Tomato powder | 29 |
| Potassium chloride | 1 |
| | Weight (g) |
| Minced meat (beef) | 150.00 |
| Tomato, diced | 200.00 |
| Tomato paste, CB 28 °Brix | 160.00 |
| Sugar | 8.00 |
| Vegetable oil | 8.00 |
| Colflo | 8.00 |
| Salt | 11.00 |
| Red bell pepper, diced | 25.00 |
| Onion, diced | 25.00 |
| Carrot, diced | 25.00 |
| Cellery, diced | 10.00 |
| Mushroom, diced | 15.00 |
| Garlic, diced | 2.00 |
| Basil, FD | 0.50 |
| HY YEP C ex Quest ™ (product code 34743) | 1.00 |
| Flavour Beef broth ex Quest ™ | 0.60 |
| (product code QL36287) | |
| Water | 350.90 |
| | 100.00 |

Preparation

The meat was fried, following which the tomato puree and the diced vegetables were added. Subsequently, water and the remaining ingredients were added. The resulting preparation was cut into small pieces with a food processor.

The sauce was divided in two equal portions (I) and (II). Flavouring composition (B) and citric acid were added to portion (I) in amounts of 1.1 wt. % and 0.28 wt. % respectively. After preparation, the pH of portion (I) of the sauce was found to be 4.2. The pH of portion (II) was adjusted to 4.1 with citric acid.

Both portions of the sauce were hot-filled and packaged after pasteurisation (5 minutes at 95° C.) and were found to exhibit excellent shelf-life, i.e. to be microbiologically stable for more than 6 months at 20° C.

A double blind evaluation of portions (I) and (II) revealed that portion (I) was generally preferred as being less sour and having a more balanced taste.

1-16. (canceled)

17. A flavouring composition comprising at least 5% by weight of dry matter of glycine hydrochloride or a turmeric component or both, wherein the turmeric component is turmeric, a derivative of turmeric containing curcumin, or any combinations thereof, and further wherein the weight ratio of turmeric component to glycine hydrochloride is less than 1:5.

18. The flavouring composition according to claim 17, wherein the turmeric component is present in a concentration of less than 2% by weight of dry matter.

19. The flavouring composition according to claim 17, wherein the composition contains less than 20 wt. % water.

20. The flavouring composition according to claim 17, wherein the composition is a free flowing powder.

21. The flavouring composition according to claim 17, wherein the composition further contains at least 10% by weight of dry matter of at least one component selected from the group consisting of yeast lysates, processed flavours and topnotes.

22. A method of flavouring a foodstuff or a beverage comprising the step of incorporating into said foodstuff or beverage between 0.01 and 2.0 wt. % of a flavouring composition according to claim 17.

23. The method according to claim 22, wherein the flavouring composition is incorporated into the foodstuff or beverage in an amount effective to deliver at least 0.005% of glycine hydrochloride by weight of the foodstuff or beverage.

24. The method according to claim 22, wherein the foodstuff or beverage contains at least 20 wt. % water.

25. The method according to claim 24, wherein said water has a pH within the range of 2.0-5.0.

26. The method according to claim 22, wherein the foodstuff is selected from the group consisting of sauces, soups, dressing and mayonnaise.

27. A water containing foodstuff or beverage with a pH of less than 4.5, wherein said foodstuff or beverage contains at least 0.01 wt. % glycine hydrochloride, between 0 and 0.01 wt. % turmeric, and wherein the weight ratio of glycine hydrochloride to turmeric exceeds 5.

28. A water containing foodstuff or beverage with a pH of less than 4.5, wherein said foodstuff or beverage contains at least 0.05 wt. % glycine hydrochloride.

29. The foodstuff or beverage according to claim 28, wherein said foodstuff or beverage is water-continuous.

30. A process of manufacturing a flavouring composition, said process comprising the step of dry blending glycine hydrochloride with at least one flavouring ingredient.

31. The flavouring composition according to claim 17, comprising at least 10% by weight of dry matter of glycine hydrochloride, or a turmeric component, or both.

32. The flavouring composition according to claim 17, wherein the weight ratio of turmeric component to glycine hydrochloride is less than 1:10.

33. The flavouring composition according to claim 17, wherein the turmeric component is present in a concentration of less than 1% by weight of dry matter.

34. The flavouring composition according to claim 17, wherein the composition contains less than 10 wt. % water.

35. The method according to claim 22, wherein the foodstuff or beverage contains at least 40 wt. % water.

36. The method according to claim 24, wherein said water has a pH within the range of 3.0-4.5.
